(19) United States
(12) Patent Application Publication
(10) Pub. No.: US 2018/0364532 A1
(43) Pub. Date: Dec. 20, 2018

(54) ARRAY SUBSTRATE AND LIQUID CRYSTAL PANELS

(71) Applicant: Shenzhen China Star Optoelectronics Technology Co. Ltd., Shenzhen, Guangdong (CN)

(72) Inventor: Xiangyang XU, Shenzhen, Guangdong (CN)

(73) Assignee: Shenzhen China Star Optoelectronics Technology Co. , Ltd., Shenzhen, Guangdong (CN)

(21) Appl. No.: 15/558,536

(22) PCT Filed: Jul. 17, 2017
(86) PCT No.: PCT/CN2017/093072

§ 371 Date: Sep. 14, 2017

(30) Foreign Application Priority Data
Jun. 20, 2017 (CN) 201710468772.1

(51) Int. Cl. G02F 1/1362

(52) U.S. Cl. CPC G02F 1/136286; G02F 2001/133388

(57) ABSTRACT

The present disclosure relates to an array substrate and a liquid crystal panel. The common electrode wirings of the array substrate include a plurality of common electrode sub-wirings, two first-common-electrode-wirings, and at least one second-common-electrode-wiring. The active area of the array substrate is divided into at least two areas along an extending direction of the scanning line. Each of the second-common-electrode-wirings is configured between two adjacent areas.

### BACKGROUND OF THE INVENTION

### 1. Field of the Invention

The present disclosure relates to display technology, and more particularly to an array substrate and a liquid crystal panel.

### 2. Discussion of the Related Art

With respect to the Liquid crystal devices (LCDs), the alignment of the liquid crystal molecules are usually controlled by the electric field between the pixel electrode and the common electrode. As shown in FIG. 1, the LCD turns on the thin film transistors (TFTs) within each of the pixel areas 12 by scanning lines 11, apples grayscale voltage to the pixel electrodes within each of the pixel areas 12 by data lines 13, and provides the common voltage to the common electrode by common electrode wirings 14. The scanning lines 11, the hole transport layer 13, and the common electrode wirings 14 respectively connects to electro-static discharge (ESD) components 14 so as to perform the electro-static discharge protection to the driving circuit of the LCD. Also referring to FIG. 2, the common electrode wirings 14 includes two common electrode wirings 141 and a plurality of common electrode sub-wiring 142. The two common electrode wirings 141 are connected by a connecting wiring 143. Any two adjacent common electrode sub-wirings 142 are parallel to each other, and are spaced apart from each other. Two ends of each of the common electrode sub-wirings 142 respectively connects to two common electrode wirings 141 to receive the common voltage. Due to the resistance of the wirings, the common voltages received by each of the common electrode sub-wiring 142 is smaller along a direction farther away from the common electrode wirings 141. As such, the uniformity of the driven common voltage is bad, which affects the performance of the LCD.

### SUMMARY

The present disclosure relates to an array substrate and a liquid crystal panel to enhance the uniformity of the driven common voltage so as to enhance the display performance.

In one aspect, an array substrate includes: an active area and a non-display area; the active area comprising a plurality of data lines and a plurality of scanning lines intersecting with the data lines to define a plurality of pixel areas of the array substrate; the non-display area comprising two first-common-electrode-wirings parallel to the data lines, and a connecting wiring parallel to the scanning lines, and the two first-common-electrode-wirings being respectively configured at two sides of the active area; the active area further includes: a second-common-electrode-wiring parallel to the data line, the active area being divided into two areas by the second-common-electrode-wiring along an extending direction of the scanning line, and a dimension of the two areas are the same, each of the second-common-electrode-wirings being arranged between the two adjacent areas, and the second-common-electrode-wiring and the first-common-electrode-wirings being connected by the connecting wiring; a plurality of common electrode sub-wirings parallel to the scanning lines, and each of the common electrode sub-wirings being connected with the first-common-electrode-wirings and the second-common-electrode-wirings.

Wherein along a visual direction perpendicular to the array substrate, the pixel areas at two sides of the second-common-electrode-wiring are symmetric to each other with respect to the second-common-electrode-wiring.

In another aspect, an array substrate includes: an active area and a non-display area; the active area comprising a plurality of data lines and a plurality of scanning lines intersecting with the data lines to define a plurality of pixel areas of the array substrate;

the non-display area comprising two first-common-electrode-wirings parallel to the data lines, and the two first-common-electrode-wirings being respectively configured at two sides of the active area; the active area further includes: a second-common-electrode-wiring parallel to the data line, the active area being divided into two areas by the second-common-electrode-wiring along an extending direction of the scanning line, and each of the second-common-electrode-wirings being arranged between the two adjacent areas; a plurality of common electrode sub-wirings parallel to the scanning lines, and each of the common electrode sub-wirings being connected with the first-common-electrode-wirings and the second-common-electrode-wirings.

Wherein the array substrate further comprises a connecting wiring parallel to the scanning lines, and the second-common-electrode-wiring and the first-common-electrode-wirings are connected by the connecting wiring.

Wherein the connecting wiring is arranged within the non-display area.

Wherein the active area is divided into two areas along an extending direction of the scanning line, and a dimension of the two areas are the same, and the array substrate comprises one second-common-electrode-wiring.

Wherein along a visual direction perpendicular to the array substrate, the pixel areas at two sides of the second-common-electrode-wiring are symmetric to each other with respect to the second-common-electrode-wiring.

In another aspect, a liquid crystal panel includes: an array substrate and a color filter (CF) substrate, and the array substrate comprising an active area and a non-display area, the active area comprising a plurality of data lines and a plurality of scanning lines intersecting with the data lines to define a plurality of pixel areas of the array substrate; the non-display area comprising two first-common-electrode-wirings parallel to the data lines, and the two first-common-electrode-wirings being respectively configured at two sides of the active area; the active area further includes: at least one second-common-electrode-wiring parallel to the data line, the active area being divided into two areas by the second-common-electrode-wiring along an extending direction of the scanning line, and each of the second-common-electrode-wirings being arranged between the two adjacent areas; a plurality of common electrode sub-wirings parallel to the scanning lines, and each of the common electrode sub-wirings being connected with the first-common-electrode-wirings and the second-common-electrode-wirings.

Wherein the array substrate further comprises a connecting wiring parallel to the scanning lines, and the second-common-electrode-wiring and the first-common-electrode-wirings are connected by the connecting wiring.

Wherein the connecting wiring is arranged within the non-display area.

Wherein the active area is divided into two areas along an extending direction of the scanning line, and a dimension of the two areas are the same, and the array substrate comprises one second-common-electrode-wiring.

Wherein along a visual direction perpendicular to the array substrate, the pixel areas at two sides of the second-common-electrode-wiring are symmetric to each other with respect to the second-common-electrode-wiring.

In view of the above, the active area of the array substrate is divided into at least two areas along the extending direction of the scanning line. At least one second-common-electrode-wiring connects between each of the common electrode sub-wirings. As such, the transmitting distance of the common voltage within each of the common electrode sub-wirings may be reduced. That is, the transmitting distance of the common voltage within each of the common electrode sub-wirings may be reduced. As such, the wiring resistance may be decreased to enhance the uniformity of the driven common voltage so as to enhance the display performance of the liquid crystal panel.

### BRIEF DESCRIPTION OF THE DRAWINGS

FIG. 1 is an equivalent circuit diagram of the driving circuit of one conventional LCD.

FIG. 2 is a schematic view of the common electrode wirings of FIG. 1.

FIG. 3 is a schematic view of the liquid crystal panel in accordance with one embodiment of the present disclosure.

FIG. 4 is an equivalent circuit diagram of the driving circuit in accordance with one embodiment of the present disclosure.

FIG. 5 is a schematic view of the common electrode wirings of FIG. 4.

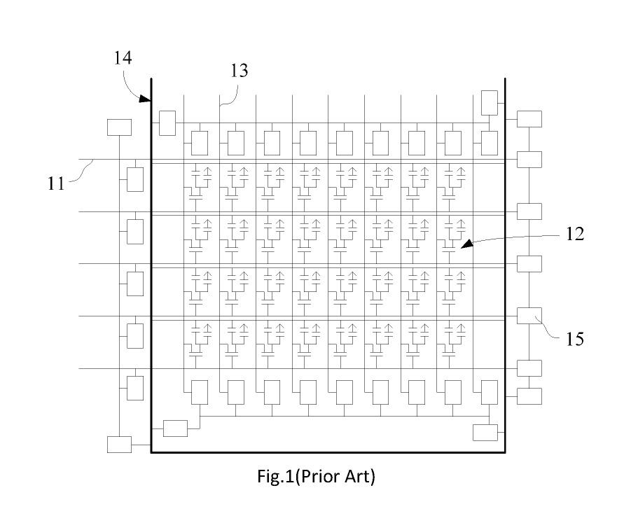

### DETAILED DESCRIPTION OF THE EMBODIMENTS

Embodiments of the invention will now be described more fully hereinafter with reference to the accompanying drawings, in which embodiments of the invention are shown.

FIG. 3 is a schematic view of the liquid crystal panel in accordance with one embodiment of the present disclosure. The liquid crystal panel 30 includes a color filter (CF) substrate 31, an array substrate 32, and liquid crystal molecules 33 filled between the two substrates, wherein the two substrates are spaced apart from each other. The liquid crystal molecules 33 are disposed within a liquid crystal cell formed by the CF substrate 31 and the array substrate 32.

The CF substrate 31 is configured with at least one common electrode. In an example, the CF substrate 31 is a transparent conductive film, i.e., Indium Tin Oxide (ITO) film.

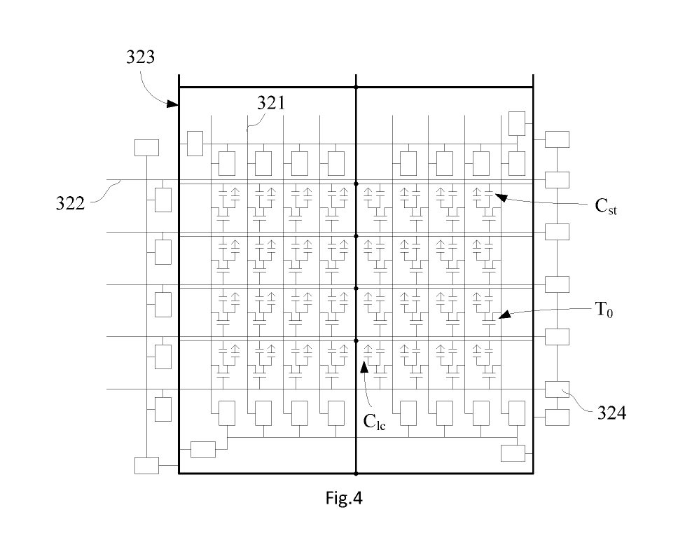

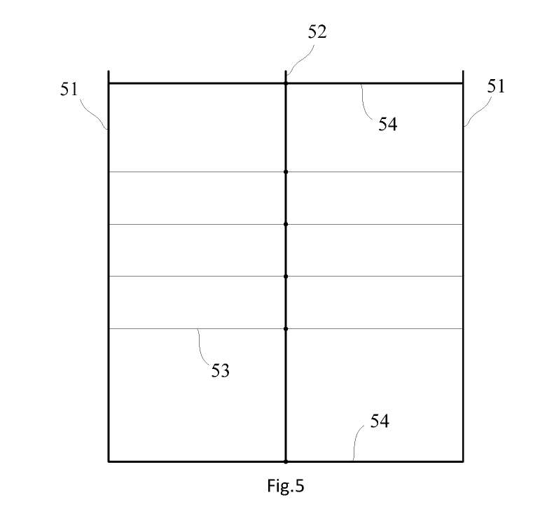

Referring to FIG. 4, the array substrate 32 includes a plurality of data lines 321 arranged along a column direction, a plurality of scanning lines 322 arranged along a row direction, common electrode wirings 323, and a plurality of pixel areas defined by the scanning lines 322 and the data lines 321.

Each of the pixel area connects to a corresponding data line 321 and a corresponding scanning line 322. Each of the scanning lines 322 connects to a gate driver to provide scanning voltage to each of the pixel areas. Each of the data lines 321 connects to a source driver to provide grayscale voltages to each of the pixel areas. Further, each of the pixel areas includes a TFT (T₀), a storage capacitor (Cₛₜ), and a liquid crystal capacitor (C_{lc}). The liquid crystal capacitor (C_{lc}) is formed by the pixel electrode, the common electrode arranged at one side of the CF substrate 31, and the liquid crystal molecules 33 between the CF substrate 31 and the liquid crystal molecules 33. The storage capacitor (Cₛₜ) is formed by the pixel electrode, common electrode wirings 323, and the liquid crystal molecules 33 between the pixel electrode and the common electrode wirings 323.

According to the display principle of the liquid crystal panel 30, the TFTs (T₀) arranged on the n-th row are turned on simultaneously when the scanning lines 322 inputs the scanning voltage. After a time period, the TFTs (T₀) arranged on the (n+1)-th row are turned on simultaneously. As the turn-on period of the TFT (T₀) on each of the rows is short, the time period for the liquid crystal capacitor (C_{lc}) to control the alignment of the liquid crystal molecules 33 is short, which may not reach a response time of the, which may not reach a response time of the 33. The storage capacitor (Cₛₜ) may maintain the voltage of the pixel area after the TFT (T₀) is turned off.

Referring to FIG. 5, the common electrode wirings 323 of the storage capacitor (Cₛₜ) includes two first-common-electrode-wirings 51, one second-common-electrode-wiring 52, and a plurality of common electrode sub-wirings 53.

The first-common-electrode-wirings 51 is arranged within a non-display area of the array substrate 32, and is parallel to the data lines 321. The two first-common-electrode-wirings 51 are respectively arranged at two sides of the pixel areas, that is, the two first-common-electrode-wirings 51 are respectively arranged at two sides of the active area of the liquid crystal panel 30.

The second-common-electrode-wiring 52 is arranged within an active area of the liquid crystal panel 30, and is parallel to the data lines 321. The active area, i.e., all of the pixel areas, of the liquid crystal panel 30 is divided into two areas along an extending direction of the scanning lines 322. The dimension of the two areas may be the same, and the second-common-electrode-wiring 52 is arranged between the two areas. In addition, the second-common-electrode-wiring 52 and the first-common-electrode-wirings 51 are connected by the wirings parallel to the scanning lines 322.

To facilitate the wiring configuration, in the embodiment, the pixel areas arranged at two sides of the second-common-electrode-wiring 52 are symmetric to each other with respect to the second-common-electrode-wiring 52. In an example, along a visual direction perpendicular to the array substrate 32, the data lines 321 are arranged at a left side of the corresponding pixel areas with respect to the pixel areas arranged at the left side, as shown in FIG. 5. In addition, the data lines 321 are arranged at a right side of the corresponding pixel area with respect to the pixel areas arranged at the right side, as shown in FIG. 5. It can be understood that the TFT (T₀), the storage capacitor (Cₛₜ), or the liquid crystal capacitor (C_{lc}) configured within the pixel areas at two sides may be symmetrical with respect to the second-common-electrode-wiring 52.

The common electrode sub-wirings 53 are arranged within the active area of the liquid crystal panel 30, and are parallel to the scanning lines 322. Each of the common electrode sub-wirings 53 connects to the first-common-electrode-wirings 51 and the second-common-electrode-wiring 52.

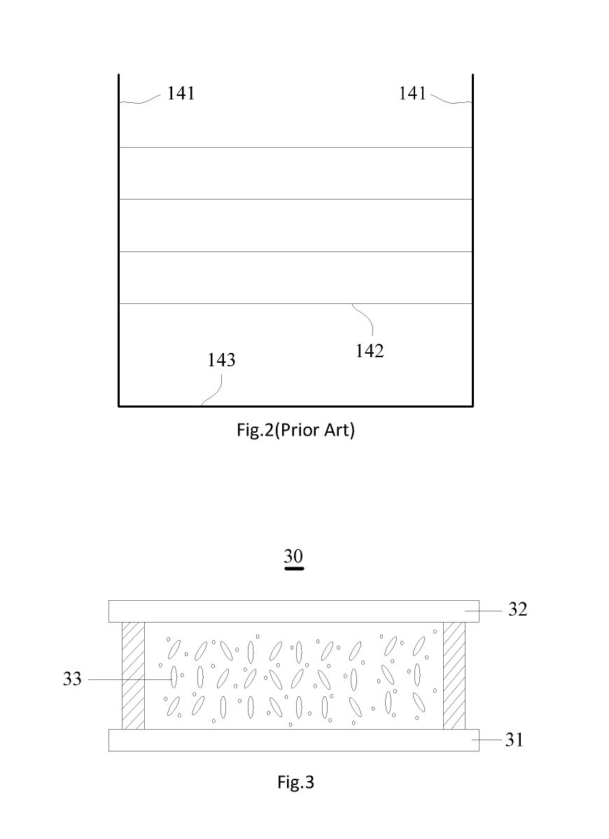

In an example, the first-common-electrode-wirings 51 and the second-common-electrode-wiring 52 may apply the common voltage to the liquid crystal panel 30. Compared to the conventional technology as shown in FIG. 2, when the common electrode sub-wirings 53 arranged at the same row are deemed as one common electrode sub-wiring 142 in FIG. 2, at least one second-common-electrode-wiring 52 connects between each of the common electrode sub-wirings 142. As such, the transmitting distance of the common voltage within each of the common electrode sub-wirings 142 may be reduced. That is, the transmitting distance of the common voltage within each of the common electrode sub-wirings 53 may be reduced. As such, the wiring resistance may be decreased to enhance the uniformity of the driven common voltage so as to enhance the display performance of the liquid crystal panel 30.

In view of the above, the common electrode wirings 323 may include two or more than two second-common-electrode-wirings 52. As such, the active area of the liquid crystal panel 30 may include at least two area along the extending area of the scanning lines 322, and at least one second-common-electrode-wiring 52 is configured between two adjacent areas.

It can be understood that the array substrate 32 may include components other than the data lines 321, the scanning lines 322, and the common electrode wirings 323, such as at least one ESD 324, which may provide the electro-static discharge for the driving circuit.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
an active area and a non-display area;
the active area comprising a plurality of data lines and a plurality of scanning lines intersecting with the data lines to define a plurality of pixel areas of the array substrate;
the non-display area comprising two first-common-electrode-wirings parallel to the data lines, and a connecting wiring parallel to the scanning lines, and the two first-common-electrode-wirings being respectively configured at two sides of the active area;
the active area further comprising:
a second-common-electrode-wiring parallel to the data line, the active area being divided into two areas by the second-common-electrode-wiring along an extending direction of the scanning line, and a dimension of the two areas are the same, each of the second-common-electrode-wirings being arranged between the two adjacent areas, and the second-common-electrode-wiring and the first-common-electrode-wirings being connected by the connecting wiring;
a plurality of common electrode sub-wirings parallel to the scanning lines, and each of the common electrode sub-wirings being connected with the first-common-electrode-wirings and the second-common-electrode-wirings.

2. The array substrate as claimed in claim 1, wherein along a visual direction perpendicular to the array substrate, the pixel areas at two sides of the second-common-electrode-wiring are symmetric to each other with respect to the second-common-electrode-wiring.

3. An array substrate, comprising:
an active area and a non-display area;
the active area comprising a plurality of data lines and a plurality of scanning lines intersecting with the data lines to define a plurality of pixel areas of the array substrate;
the non-display area comprising two first-common-electrode-wirings parallel to the data lines, and the two first-common-electrode-wirings being respectively configured at two sides of the active area;
the active area further comprising:
a second-common-electrode-wiring parallel to the data line, the active area being divided into two areas by the second-common-electrode-wiring along an extending direction of the scanning line, and each of the second-common-electrode-wirings being arranged between the two adjacent areas;
a plurality of common electrode sub-wirings parallel to the scanning lines, and each of the common electrode sub-wirings being connected with the first-common-electrode-wirings and the second-common-electrode-wirings.

4. The array substrate as claimed in claim 3, wherein the array substrate further comprises a connecting wiring parallel to the scanning lines, and the second-common-electrode-wiring and the first-common-electrode-wirings are connected by the connecting wiring.

5. The array substrate as claimed in claim 4, wherein the connecting wiring is arranged within the non-display area.

6. The array substrate as claimed in claim 3, wherein the active area is divided into two areas along an extending direction of the scanning line, and a dimension of the two areas are the same, and the array substrate comprises one second-common-electrode-wiring.

7. The array substrate as claimed in claim 6, wherein along a visual direction perpendicular to the array substrate, the pixel areas at two sides of the second-common-electrode-wiring are symmetric to each other with respect to the second-common-electrode-wiring.

8. A liquid crystal panel, comprising:
an array substrate and a color filter (CF) substrate, and the array substrate comprising an active area and a non-display area, the active area comprising a plurality of data lines and a plurality of scanning lines intersecting with the data lines to define a plurality of pixel areas of the array substrate;
the non-display area comprising two first-common-electrode-wirings parallel to the data lines, and the two first-common-electrode-wirings being respectively configured at two sides of the active area;
the active area further comprising:
at least one second-common-electrode-wiring parallel to the data line, the active area being divided into two areas by the second-common-electrode-wiring along an extending direction of the scanning line, and each of the second-common-electrode-wirings being arranged between the two adjacent areas;
a plurality of common electrode sub-wirings parallel to the scanning lines, and each of the common electrode sub-wirings being connected with the first-common-electrode-wirings and the second-common-electrode-wirings.

9. The liquid crystal panel as claimed in claim 8, wherein the array substrate further comprises a connecting wiring parallel to the scanning lines, and the second-common-electrode-wiring and the first-common-electrode-wirings are connected by the connecting wiring.

10. The liquid crystal panel as claimed in claim 9, wherein the connecting wiring is arranged within the non-display area.

11. The liquid crystal panel as claimed in claim 8, wherein the active area is divided into two areas along an extending direction of the scanning line, and a dimension of the two areas are the same, and the array substrate comprises one second-common-electrode-wiring.

12. The liquid crystal panel as claimed in claim 11, wherein along a visual direction perpendicular to the array substrate, the pixel areas at two sides of the second-common-electrode-wiring are symmetric to each other with respect to the second-common-electrode-wiring.
